(19) United States
(12) Patent Application Publication
(10) Pub. No.: US 2015/0154149 A1
(43) Pub. Date: Jun. 4, 2015

(54) TYPESETTING METHOD, DEVICE AND SYSTEM

(71) Applicant: Tencent Technology (Shenzhen) Company Limited, Shenzhen, GU (CN)

(72) Inventors: Yongxia Liu, Shenzhen (CN); Weiyu Dou, Shenzhen (CN); Xuebin Liu, Shenzhen (CN); Kaixiang Zhang, Shenzhen (CN)

(21) Appl. No.: 14/403,969

(22) PCT Filed: May 31, 2013
(86) PCT No.: PCT/CN2013/076589

§ 371 Date: Nov. 25, 2014

(30) Foreign Application Priority Data
Jun. 1, 2012 (CN) 201210179042.7

(51) Int. Cl. G06F 17/21; G06F 17/24; G06F 17/22

(52) U.S. Cl. CPC G06F 17/211; G06F 17/214; G06F 17/2247; G06F 17/248

(57) ABSTRACT

A typesetting method, device and system is disclosed. The method includes: receiving unique identification information, contents to be typeset and screen information which are uploaded by a mobile terminal; searching for typesetting protocol data corresponding to the mobile terminal according to the unique identification information; typesetting the contents to be typeset according to the screen information and the typesetting protocol data, and feeding back the typeset contents to the mobile terminal. By completing a typesetting process via a server and then issuing a typeset text area to a mobile terminal, the application achieves the effect that the mobile terminal can rapidly and accurately complete the typesetting process by means of the server, and can still rapidly and accurately display related characters to a user even if characters to be typeset contain complex multi-language characters.

The present application claims the priority of Chinese Patent Application No. 2012101790427, filed to Patent Office of the People's Republic of China on Jun. 1, 2012, entitled “Typesetting Method, Device and System”, the entire contents of which are incorporated herein by reference.

### FIELD OF THE INVENTION

The application relates to the field of internet information processing, and particularly relates to a typesetting method, device and system.

### BACKGROUND

Typesetting is a process of adjusting the position and size of words, pictures, graphs and other visual information elements in terms of page layout to organize the page layout. Wherein, it has become a hot research topic in the prior art how to typeset on a mobile terminal such as an intelligent mobile phone or a tablet computer has become a hot research topic in the prior art.

For a mobile terminal, an existing typesetting method is as follows: first, the mobile terminal acquires contents to be typeset, wherein the contents to be typeset may be several characters each corresponding to an actual word, for example, a word “-”, which may be stored and represented by characters “04e00” in the mobile terminal; second, the mobile terminal acquires typesetting information corresponding to the contents to be typeset, wherein the typesetting information includes information such as font size, font style and font height to be used during typesetting, for example, the typesetting information herein may be represented as: font size: “12 pt”; font style: “Simsum”; and font height: “4.2 mm”; and finally, the mobile terminal typesets the contents to be typeset according to the typesetting information. The typesetting information may also be referred to as typesetting rules, typesetting protocol data or other names.

During the implementation of the application, the inventor finds that there are at least the following problems in the prior art: as both the computing power and the memory space of a mobile terminal are limited, the typesetting capability provided by the mobile terminal is relatively poor when huge computation is required during typesetting (for example, the contents to be typeset contains special multi-language characters).

### SUMMARY OF THE INVENTION

To solve the problems of a low typesetting speed or poor typesetting effect of a mobile terminal caused by the poor typesetting capability provided by the mobile terminal, embodiments of the application provide a typesetting method and device. The technical solutions are as follows.

According to one aspect of the application, the embodiments of the application provide a typesetting method, wherein the method includes:

receiving unique identification information, contents to be typeset and screen information which are uploaded by a mobile terminal;

searching for typesetting protocol data corresponding to the mobile terminal according to the unique identification information; and

typesetting the contents to be typeset according to the screen information and the typesetting protocol data, and feeding back the typeset content to the mobile terminal.

Further, before receiving the unique identification information, the contents to be typeset and the screen information which are uploaded by the mobile terminal, the method further includes:

receiving a typesetting protocol data uploading request initiated by the mobile terminal, wherein the typesetting protocol data uploading request includes unique identification information;

judging whether typesetting protocol data corresponding to the unique identification information has already been stored; and

feeding back an uploading determination instruction to the mobile terminal if the typesetting protocol data corresponding to the unique identification information has not yet been stored, so as to receive and store the typesetting protocol data uploaded by the mobile terminal.

Further, the typesetting protocol data includes header information, common character typesetting information and special character typesetting information;

the header information includes font size information, font style information and font height information during typesetting;

the common character typesetting information includes width information of a single character; and

the special character typesetting information includes supported type information of the special character, typesetting type information of the special character, and character data corresponding to the typesetting type information of the special character.

Further, typesetting the contents to be typeset according to the screen information and the typesetting protocol data specifically includes:

determining a typesetting area according to the screen information;

judging in turn whether each character contained in the contents to be typeset is a special character;

typesetting the character to the typesetting area according to the common character typesetting information if the character contained in the contents to be typeset is not a special character; and

typesetting the character to the typesetting area according to the special character typesetting information if the character contained in the contents to be typeset is a special character.

Further, typesetting the character to the typesetting area according to the special character typesetting information specifically includes:

judging, according to the supported type information of the special character, whether the typesetting of the current special character is supported; and

typesetting the current special character to the typesetting area according to the typesetting type information of the special character and the character data corresponding to the typesetting type information of the special character if the typesetting of the current special character is supported.

Further, receiving the unique identification information, the contents to be typeset and the screen information uploaded by the mobile terminal specifically includes:

receiving a webpage address uploaded by the mobile terminal; and

acquiring webpage data according to the webpage address, and using the acquired webpage data as the contents to be typeset.

According to another aspect of the application, the embodiments of the application further provide a typesetting method, wherein the method includes:

uploading unique identification information, contents to be typeset and screen information to a server, the unique identification information corresponds to typesetting protocol data required by typesetting; and

receiving the typeset contents fed back by the server, the typeset contents are contents which are acquired after the server typesets the contents to be typeset according to the typesetting protocol data and the screen information.

Further, before uploading the unique identification information, the contents to be typeset and the screen information to the server, the method further includes:

generating the unique identification information according to the typesetting protocol data to be uploaded;

uploading the unique identification information to the server so that the server judges whether it is required to upload the typesetting protocol data; and

uploading the typesetting protocol data to the server after receiving an uploading determination instruction fed back by the server.

According to yet another aspect of the application, the embodiments of the application further provide a server, wherein the server includes:

an information receiving module, which is configured to receive unique identification information, contents to be typeset and screen information uploaded by a mobile terminal;

a protocol searching module, which is configured to search for typesetting protocol data corresponding to the mobile terminal according to the unique identification information; and

a content typesetting module, which is configured to typeset the contents to be typeset according to the screen information and the typesetting protocol data, and feed back the typeset content to the mobile terminal.

Further, the server further includes: a pre-receiving module, a protocol judging module and a protocol receiving module;

the pre-receiving module is configured to receive the unique identification information uploaded by the mobile terminal;

the protocol judging module is configured to judge whether typesetting protocol data corresponding to the unique identification information has already been stored; and

the protocol receiving module is configured to feed back an uploading determination instruction to the mobile terminal if the typesetting protocol data corresponding to the unique identification information has not yet been stored, so as to receive and store the typesetting protocol data uploaded by the mobile terminal.

Further, the typesetting protocol data includes header information, common character typesetting information and special character typesetting information;

the header information comprises font size information, font style information and font height information during typesetting;

the common character typesetting information comprises width information of a single character; and

the special character typesetting information comprises the supported type information of the special character, typesetting type information of the special character, and character data corresponding to the typesetting type information of the special character.

Further, the content typesetting module specifically includes:

an area determining unit, a character judging module, a common typesetting unit and a special typesetting unit;

the area determining unit is configured to determine a typesetting area according to the screen information;

the character judging module is configured to judge in turn whether each character contained in the contents to be typeset is a special character;

the common typesetting unit is configured to typeset the character to the typesetting area according to the common character typesetting information if a character contained in the contents to be typeset is not a special character; and

the special typesetting unit is configured to typeset the character to the typesetting area according to the special character typesetting information if a character contained in the characters to be typeset is a special character.

Further, the special typesetting unit specifically includes:

a typesetting judging subunit and a special typesetting subunit;

the typesetting judging subunit is configured to judge, according to the supported type information of the special character, whether the typesetting of the current special character is supported; and

the special typesetting subunit is configured to typeset the current special character to the typesetting area according to the typesetting type information of the special character and the character data corresponding to the typesetting type information of the special character if the typesetting judging subunit judges that the typesetting of the current special character is supported.

Further, the information receiving module specifically includes:

an address receiving unit and a data acquiring unit;

the address receiving unit is configured to receive a webpage address uploaded by the mobile terminal; and

the data acquiring unit is configured to acquire webpage data according to the webpage address, and use the acquired webpage data as the contents to be typeset.

According to another aspect of the application, the embodiments of the application further provide a mobile terminal, wherein the mobile terminal includes:

an information receiving module, which is configured to upload unique identification information, contents to be typeset and screen information to a server, the unique identification information corresponds to typesetting protocol data required by typesetting; and

a typesetting receiving module, which is configured to receive the typeset contents fed back by the server, the typeset contents are contents which are acquired after the server typesets the contents to be typeset according to the typesetting protocol data and the screen information.

Further, the mobile terminal further includes:

an information generation module, a pre-uploading module and a data uploading module;

the information generation module is configured to generate the unique identification information according to the typesetting protocol data to be uploaded;

the pre-uploading module is configured to upload the unique identification information to the server so that the server judges whether it is required to upload the typesetting protocol data; and

the data uploading module is configured to upload the typesetting protocol data to the server after receiving an uploading determination instruction fed back by the server.

According to another aspect of the application, the embodiments of the application further provide a typesetting system, wherein the typesetting system includes the server according to any one of the above solutions and the mobile terminal according to any one of the above solutions.

The technical solutions provided by the embodiments of the application achieve the following advantages:

by completing a typesetting process via a server and then issuing a typeset content to a mobile terminal, the application solves the problems of a low typesetting speed or poor typesetting effect of the mobile terminal caused by the poor typesetting capability provided by the mobile terminal, and achieves the effect that the mobile terminal can rapidly and accurately complete the typesetting process by means of the server, and can still rapidly and accurately display related characters to a user even if contents to be typeset contains special multi-language characters.

### DESCRIPTION OF THE DRAWINGS

To describe the technical solutions in the embodiments of the application more clearly, the accompanying drawings to be used for describing the embodiments will be briefly introduced as below. Apparently, the accompanying drawings in the following description are merely some embodiments of the application, based on which those of ordinary skill in the art may obtain other drawings without creative efforts.

FIG. 1A is a flow diagram of a typesetting method provided by Embodiment 1 of the application;

FIG. 1B is an implementation schematic diagram of the typesetting method provided by Embodiment 1 of the application;

FIG. 2 is a flow diagram of a typesetting method provided by Embodiment 2 of the application;

FIG. 3 is a structural block diagram of a typesetting system provided by Embodiment 3 of the application;

FIG. 4 is a structural block diagram of a mobile terminal provided by Embodiment 4 of the application;

FIG. 5 is a structural block diagram of a server provided by Embodiment 5 of the application;

FIG. 6 is another structural block diagram of the server provided by Embodiment 5 of the application;

FIG. 7 is a structural block diagram of a special typesetting unit provided by Embodiment 5 of the application;

FIG. 8 is a structural block diagram of an information receiving module provided by Embodiment 5 of the application;

FIG. 9 is a structural schematic diagram of terminal equipment related in the embodiments of the application; and

FIG. 10 is a structural schematic diagram of a server provided by the embodiments of the application.

### DETAILED DESCRIPTION

In order to make the objects, technical solutions and advantages of the application more clear, the implementations of the application will be further illustrated in details in connection with the accompanying drawings and embodiments hereinafter.

### Embodiment 1

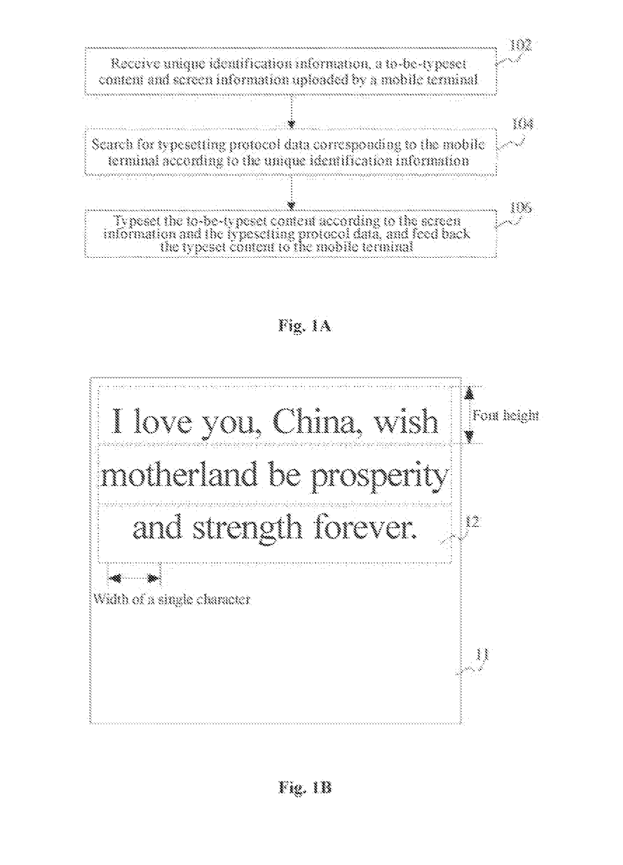

Referring to FIG. 1A, a flow diagram of a typesetting method provided by Embodiment 1 of the application is shown. The typesetting method may be applied to a system containing a mobile terminal and a server, and is mainly described from the server side in this embodiment. The server in this embodiment may also be a cloud computing center realized by a plurality of servers. The typesetting method may include:

step 102, unique identification information, contents to be typeset and screen information, which are uploaded by a mobile terminal, are received.

The server may receive the unique identification information, the contents to be typeset and the screen information which are uploaded by the mobile terminal, wherein the unique identification information corresponds to typesetting protocol data of the mobile terminal, namely typesetting information applicable to the mobile terminal. The unique identification information may be an MD5 (Message Digest Algorithm 5) computed according to the typesetting protocol data. The contents to be typeset may be several characters, or a webpage address directed to a webpage data. The screen information may be the screen resolution of the mobile terminal.

It should be noted that, the typesetting protocol data supported by the mobile terminal may be determined by the unique identification information, and the unique identification information may be computed according to a preset algorithm and the typesetting protocol data. The preset algorithm may be any characteristic value algorithm, and this embodiment of the application is described by taking the MD5 value algorithm as an example.

step 104, the typesetting protocol data corresponding to the mobile terminal is searched for according to the unique identification information.

The server may be pre-stored with multiple types of typesetting protocol data and unique identification information corresponding to each type of typesetting protocol data.

After receiving the unique identification information uploaded by the mobile terminal, the server may search for the corresponding typesetting protocol data according to the unique identification information. The found typesetting protocol data is the typesetting protocol data applicable to the mobile terminal.

step 106, the contents to be typeset are typeset according to the screen information and the typesetting protocol data, and the typeset contents are fed back to the mobile terminal.

The server may determine a typesetting area according to the screen information at first, and then typeset the contents to be typeset according to the found typesetting protocol data. It is assumed that Chinese characters are throughout the contents to be typeset, the typesetting protocol data may include font size information, font style information, font height information and width information of a single character during typesetting. In a specific example as shown in FIG. 1B, the contents to be typeset are “I love you, China, wish motherland be prosperity and strength forever”, and the server may divide the typesetting area 11 into a plurality of strip areas 12 having height equal to or slightly larger than the font height information according to the font height information and then typeset each character in the contents to be typeset in the strip areas 12 according to the width information of a single character in turn from left to right and from top to bottom so as to obtain the typeset content. During typesetting, when the character width accumulated value of all the characters in one strip area 12 exceeds the length of the strip area, the current to-be-typeset character is typeset in the strip area 12 in the next row.

After acquiring the typeset content, the server may issue the typeset content to the mobile terminal over a mobile network. The mobile terminal may render and display the typeset content issued by the server.

In conclusion, by completing a typesetting process via a server and then issuing a typeset text area to a mobile terminal, the typesetting method provided by

Embodiment 1 of the application solves the problems of a low typesetting speed or poor typesetting effect of the mobile terminal caused by the poor typesetting capability provided by the mobile terminal, and achieves the effect that the mobile terminal can rapidly and accurately complete the typesetting process by means of the server, and can still rapidly and accurately display related characters to a user even if contents to be typeset contains special multi-language characters.

### Embodiment 2

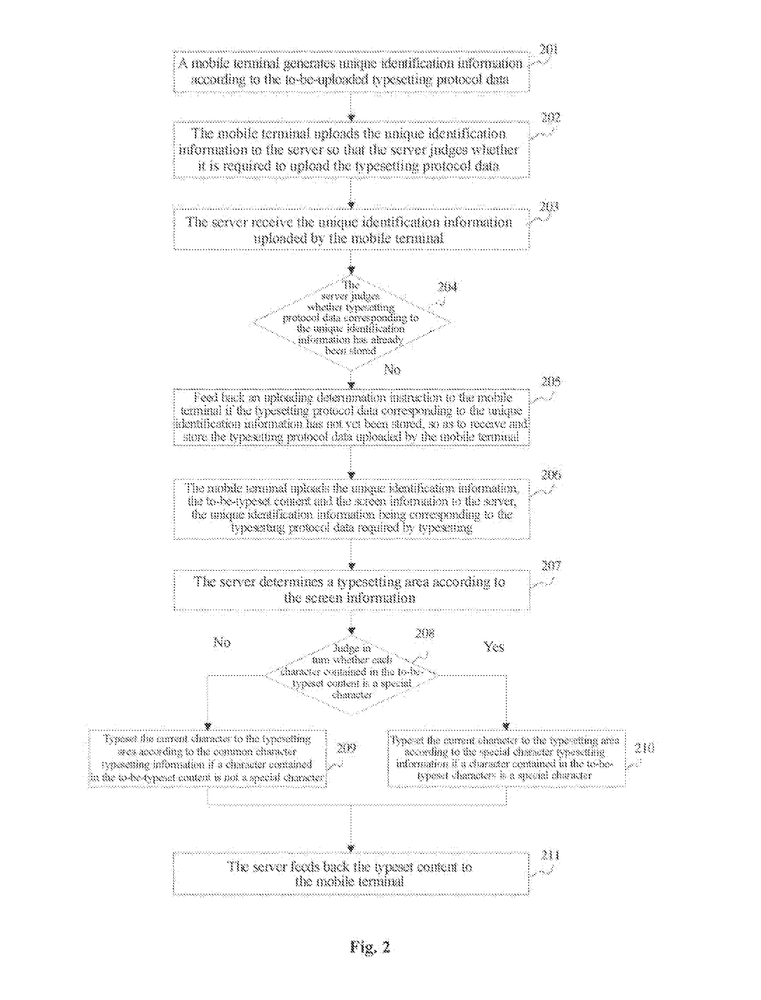

Referring to FIG. 2, a flow diagram of a typesetting method provided by Embodiment 2 of the application is shown. The typesetting method may be applied to a server or a cloud computing center realized by a plurality of servers. The typesetting method may include:

step 201, a mobile terminal generates unique identification information according to to-be-uploaded typesetting protocol data.

The mobile terminal may use its required typesetting information to generate typesetting protocol data through a predetermined protocol according to its typesetting requirements. If the mobile terminal supports the typesetting of Chinese characters only, the typesetting protocol data may only include font size information, font style information, font height information and width information of a single character during typesetting. However, in general, the mobile terminal may support the typesetting of at least English and Chinese characters, and even support the typesetting of multiple languages. At this time, the typesetting protocol data may include typesetting information for different characters or languages. To achieve server typesetting, a copy of the typesetting protocol data of the mobile terminal needs to be synchronized with the server.

However, to save the traffic of the mobile terminal, the mobile terminal does not directly upload the typesetting protocol data to the server. At this time, the mobile terminal may generate the unique identification information according to the typesetting protocol data to be uploaded. For example, the unique identification information may be realized by an MD5 (Message Digest Algorithm-5). The same typesetting protocol information may use the same unique identification information, and the unique identification information of different typesetting protocol data is different.

step 202, the mobile terminal uploads the unique identification information to the server so that the server judges whether it is required to upload the typesetting protocol data.

The mobile terminal may upload the unique identification information to the server at first so that the server judges whether it is required to upload the typesetting protocol data. The timing of uploading may be each time when the mobile terminal is started up, a network is accessed, a browser is installed or a browser is started, etc.

step 203, the server receives the unique identification information uploaded by the mobile terminal.

As for the server, the server may receive the unique identification information uploaded by the mobile terminal. The unique identification information may be carried by a typesetting protocol data uploading request sent by the mobile terminal.

step 204, the server judges whether typesetting protocol data corresponding to the unique identification information has already been stored.

The server may judge whether typesetting protocol data corresponding to the unique identification information has already been stored locally. The server may also judge whether the mobile terminal has already uploaded the same typesetting protocol data. If the server judges that the typesetting protocol data corresponding to the unique identification information is already present locally, an uploading negation instruction indicating that the typesetting protocol data does not need to be uploaded may be sent to the mobile terminal.

step 205, an uploading determination instruction is fed back to the mobile terminal if the typesetting protocol data corresponding to the unique identification information has not yet been stored, so as to receive and store the typesetting protocol data uploaded by the mobile terminal.

If the server judges that the typesetting protocol data corresponding to the unique identification information has not yet been stored locally, the server may send the uploading determination instruction indicating that the typesetting data needs to be uploaded to the mobile terminal, and the mobile terminal may upload the corresponding typesetting protocol data to the server after receiving the uploading determination instruction. To reduce the volume of transmission data, the mobile terminal may compress the typesetting protocol data in a predetermined compression way and then upload the typesetting protocol data to the server. The sent typesetting protocol data may specifically include:

header information, common character typesetting information and special character typesetting information, wherein the special character typesetting information is optional.

The header information may include font size information, font style information and font height information required by the mobile terminal during typesetting. The font size information refers to word size, for example, 12 pt, 10.5 pt and the like often used in word; font style information refers to the style of a character being displayed, for example, SimSun, SimHei, KaiTi and the like often used for Chinese characters in word; the font height information is a unique value which may be determined after determining the font size information, and usually represented by pixels.

The common character typesetting information may include width information of a single character. If it is required to typeset Chinese characters, Japanese characters, Korean characters or other block characters of a single language, the character widths of all the block characters of one language are in equal proportion. Under the same font size (i.e., word size), the character widths of the block characters of one language are same, while the character widths of the block characters of different languages may be different. For example, the character widths of Chinese characters in SimSun, KaiTi, LiSu, FZYaoti, etc. under the same word size are same; however, under the same word size, the character widths of Chinese characters are different from those of Japanese characters or Korean characters. Therefore, when the contents to be typeset are common characters of one language, the typesetting process may be completed only combining the width information of a single character of the corresponding language, in addition to the information included in the header information. Certainly, the practical typesetting process may be relatively complex. Non-block characters such as various punctuations or arithmetical operation symbols may also have different character widths under the same word size, for example, the width of letter i is less than that of letter w under the same word size. At this time, the typesetting process may still be completed only according to the width information a single character.

However, in some mobile terminals, it is required to typeset multiple languages. When a mobile terminal needs to typeset multiple languages, it is required to consider typesetting problems of special characters. That is, in some languages, such as Hindi, Thai, Arabic and so on, ligatures, variants and other special processing will occur in some characters, and many exceptional typesetting ways will be provided for the typesetting of these characters.

At this time, the typesetting protocol data may further include special character typesetting information. The special character typesetting information may include three parts, i.e., supported type information of the special character, typesetting type information of the special character, and character data corresponding to the typesetting type information of the special character. The supported type information of the special character refers to a language type in which special typesetting may be supported by the typesetting protocol data. For example, the supported type information of the special character includes Thai, Burmese, Hindi and Arabic. The typesetting type information of the special character refers to typesetting type information for a specific special character under a certain language. For example, two certain consonants in Hindi need to be joined together when they are adjacent. The character data corresponding to the typesetting type information of the special character refers to specific character data related to a typesetting rule of the special character. For example, when two consonants in Hindi are joined together, a special character “0x094d” will appear between the two consonants. In addition, the ligature width is not equal to the sum of the character widths of the two consonants, and instead, the two consonants have different values under different word sizes.

The typesetting protocol data may be a part of the typesetting rules of the terminal equipment. The header information, the common character typesetting information and the special character typesetting information are extracted from the typesetting rules by the terminal equipment. The typesetting rules may also include line spacing, indentation and other information.

The mobile terminal may upload the typesetting protocol data containing the above contents to the server, and the server may store the typesetting protocol data and the corresponding unique identification information. During storing the typesetting protocol data, if the typesetting protocol data is compressed typesetting protocol data, the server may decompress and store the typesetting protocol data.

step 201 to step 206 may be implemented when the typesetting function is installed in the mobile terminal or used for the first time. In the subsequent use, if the mobile terminal needs to perform typesetting, by simply uploading the unique identification information, the contents to be typeset and screen information to the server, the server may perform typesetting according to the received unique identification information.

step 206, the mobile terminal uploads the unique identification information, the contents to be typeset and the screen information to the server, the unique identification information corresponds to the typesetting protocol data required by typesetting.

When the mobile terminal needs to perform typesetting, the mobile terminal may upload the unique identification information, the contents to be typeset and the screen information to the server, the unique identification information corresponds to the typesetting protocol data required by typesetting. The contents to be typeset may be several characters, or a webpage address directed to a webpage data. The screen information may be the screen resolution of the mobile terminal, for example, 320 pixels*240 pixels, 960 pixels*640 pixels, etc.

As for the server, the server may receive the unique identification information, the contents to be typeset and the screen information which are uploaded by the mobile terminal. When the mobile terminal uploads the contents to be typeset, specifically, the server may further: first, receive a webpage address uploaded by the mobile terminal; and second, acquire webpage data according to the webpage address and use the acquired webpage data as the contents to be typeset.

step 207, the server determines a typesetting area according to the screen information.

As the screen information of each mobile terminal may be different, the corresponding typesetting areas are also different. The server may determine the typesetting areas according to the screen information uploaded by the mobile terminal. For example, the server may determine that the typesetting area is shown as the typesetting area 1 in FIG. 1B according to the screen information 320 pixels*240 pixels uploaded by the mobile terminal.

step 208, it is judged in turn whether each character contained in the contents to be typeset is a special character; if not, step 209 is performed; and if so, step 210 is performed.

The server may judge in turn whether each character contained in the contents to be typeset is a special character. Specifically, the characters contained in the contents to be typeset may be Unicode codes. Unicode is a character coding scheme which is formulated by International Organization and capable of containing all words and symbols in the world. Unicode sets a uniform and unique binary code for each character in each language, so as to meet the requirements for text transformation and processing across languages and platforms. The server may identify which language the character belongs to and whether the character is a special character, etc., according to the character code value of each character in the contents to be typeset.

step 209, the current character is typeset to the typesetting area according to the common character typesetting information if the current character contained in the contents to be typeset is not a special character.

If the server judges that the current character contained in the contents to be typeset is not a special character, that is, the current character contained in the contents to be typeset is a common character, then the server may typeset according to the common character typesetting information in the typesetting protocol data corresponding to the unique identification information. The common character typesetting information mainly includes character width information of a single character. In a specific example, the to-be-typeset characters are “I love you, China, wish motherland be prosperity and strength forever”, and the server may divide the typesetting area into a plurality of strip areas having height equal to or slightly larger than the font height information according to the font height information and then typeset the current character in the contents to be typeset in the strip areas according to the width information of a single character in turn from left to right and from top to bottom so as to obtain a typeset text area. During typesetting, when the character width accumulated value of all the characters in one strip area exceeds the length of the strip area, the current character is typeset in the strip area in the next row.

step 210, the current character is typeset to the typesetting area according to the special character typesetting information if the current character contained in characters to be typeset is a special character.

If the server judges that the current character contained in the contents to be typeset is a special character, it is required to typeset according to special character typesetting information in the typesetting protocol data corresponding to the unique identification information. Specifically:

First, it is judged, according to the supported type information of the special character, whether the typesetting of the current special character is supported.

The special character typesetting information includes the supported type information of the special character. When the server judges that the current character is a special character, and the type information of the special character may also be judged, for example, the server judges that the current character is Hindi, the server may judge whether the typesetting of the current special character is supported according to whether the supported type information of the special character includes Hindi. If the supported type information of the special character includes Hindi, the typesetting of the current special character is supported, and the second step will be executed. If the supported type information of the special character does not include Hindi, the typesetting of the current special character is not supported, and typesetting may only be performed according to the typesetting information defaulted by the server at this time.

Second, the current complex character is typeset to the typesetting area according to the typesetting type information of the special character and the character data corresponding to the typesetting type information of the special character if the typesetting of the current special character is supported.

When the server judges that the typesetting of the current special character is supported, the server may typeset the current special character according to the typesetting type information of the special character and the character data corresponding to the typesetting type information of the special character in the special character typesetting information. For example, when the current special character is Hindi and a special character “0x094d” appears between two consonants in the Hindi, the server may, according to the character data corresponding to the typesetting type information of the special character, find that the typesetting type information corresponding to the complex characters of the two consonants is as follows: the two consonants are joined together, and the ligature width is not equal to the sum of character widths of the two consonants, and instead, the two consonants have corresponding values under different word sizes. Then, the server may join together the two consonants for typesetting.

The above process is repeated until each character contained in the contents to be typeset has been typeset. Finally, the server will obtain the typeset contents.

step 211, the server feeds back the typeset contents to the mobile terminal.

After obtaining the typeset contents, the server may issue the typeset contents to the mobile terminal over a mobile network. The mobile terminal may render and display the typeset contents issued by the server.

In conclusion, by completing a typesetting process via a server and then issuing a typeset text area to a mobile terminal, the typesetting method provided by Embodiment 2 of the application solves the problems of a low typesetting speed or poor typesetting effect of the mobile terminal caused by the poor typesetting capability provided by the mobile terminal, and achieves the effect that the mobile terminal can rapidly and accurately complete the typesetting process by means of the server, and can still rapidly and accurately display related characters to a user even if characters to be typeset contain multi-language complex characters. In addition, by pre-uploading typesetting protocol data to the server via the mobile terminal, the typesetting method provided by Embodiment 2 of the application realizes the effect that the server may support the typesetting of multiple different mobile terminals. In another aspect, by adding special character typesetting information into the typesetting protocol data uploaded by the mobile terminal, the typesetting method provided by Embodiment 2 of the application realizes the effect that the server may support the typesetting of multi-language characters.

### Embodiment 3

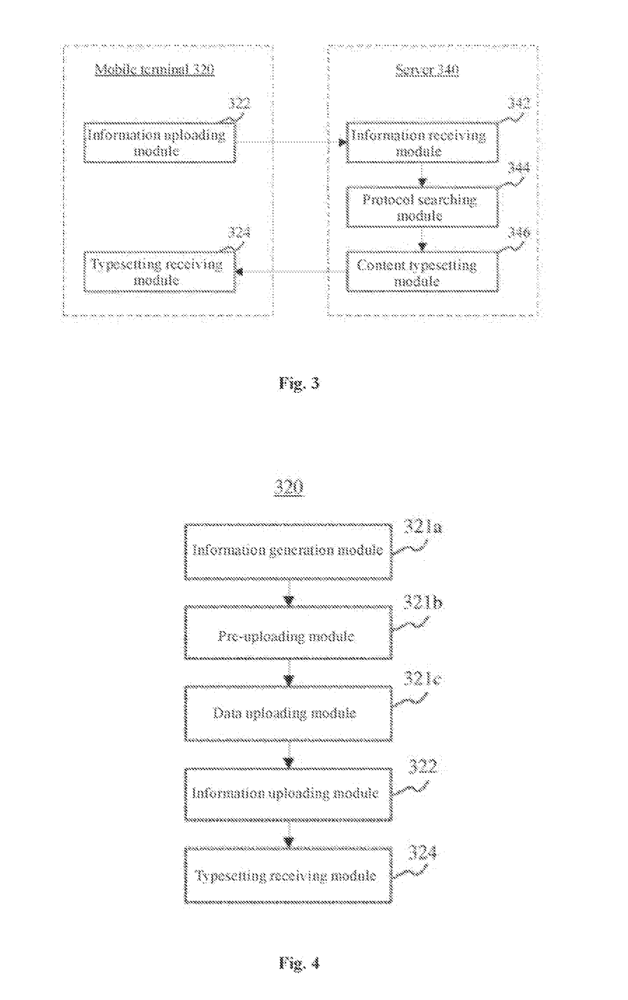

Referring to FIG. 3, a structural block diagram of a typesetting system provided by Embodiment 3 of the application is shown. The typesetting system includes at least one mobile terminal 320 and a server 340.

The mobile terminal 320 may include an information uploading module 322 and a typesetting receiving module 324.

The information uploading module 322 is configured to upload unique identification information, contents to be typeset and screen information to the server 340, the unique identification information corresponds to typesetting protocol data required by typesetting.

The typesetting receiving module 324 is configured to receive the typeset contents fed back by the server, the typeset contents are contents which are acquired after the server typesets the contents to be typeset according to the typesetting protocol data and the screen information.

The server 340 may include an information receiving module 342, a protocol searching module 344 and a content typesetting module 346.

The information receiving module 342 is configured to receive the unique identification information, the contents to be typeset and the screen information which are uploaded by the mobile terminal.

The protocol searching module 344 is configured to search for typesetting protocol data corresponding to the mobile terminal 320 according to the unique identification information.

The content typesetting module is configured to typeset the contents to be typeset according to the screen information and the typesetting protocol data, and feed back the typeset content to the mobile terminal.

In conclusion, by completing a typesetting process via a server and then issuing a typeset text area to a mobile terminal, the typesetting system provided by Embodiment 3 of the application solves the problems of a low typesetting speed or poor typesetting effect of the mobile terminal caused by the poor typesetting capability provided by the mobile terminal, and achieves the effect that the mobile terminal can rapidly and accurately complete the typesetting process by means of the server, and can still rapidly and accurately display related characters to a user even if to-be-typeset characters contain multi-language complex characters.

### Embodiment 4

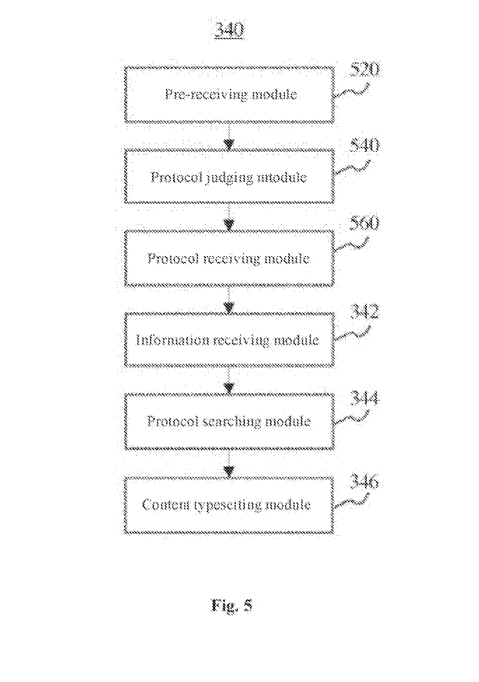

To further describe the mobile terminal in Embodiment 3, referring to FIG. 4, a structural block diagram of a mobile terminal provided by Embodiment 4 of the application is shown. The mobile terminal may include an information generation module 321a, a pre-uploading module 321b, a data uploading module 321c, an information uploading module 322 and a typesetting receiving module 324.

The information generation module 321a is configured to generate unique identification information according to typesetting protocol data to be uploaded.

The pre-uploading module 321b is configured to upload the unique identification information to a server so that the server judges whether it is required to upload the typesetting protocol data.

The data uploading module 321c is configured to upload the typesetting protocol data to the server after receiving an uploading determination instruction fed back by the server. The typesetting protocol data includes header information, common character typesetting information and special character typesetting information. The header information includes font size information, font style information and font height information during typesetting. The common character typesetting information includes width information of a single character. The special character typesetting information includes supported type information of the special character, typesetting type information of the special character, and character data corresponding to the typesetting type information of the special character.

The information uploading module 322 is configured to upload the unique identification information, the contents to be typeset and the screen information to the server, the unique identification information corresponds to the typesetting protocol data required by typesetting.

The typesetting receiving module 324 is configured to receive the typeset content fed back by the server, the typeset content being a content which is acquired after the server typesets the contents to be typeset according to the typesetting protocol data and the screen information.

In conclusion, by completing a typesetting process via a server and then issuing a typeset text area to a mobile terminal, the mobile terminal provided by Embodiment 4 of the application solves the problems of a low typesetting speed or poor typesetting effect of the mobile terminal caused by the poor typesetting capability provided by the mobile terminal, and achieves the effect that the mobile terminal can rapidly and accurately complete the typesetting process by means of the server, and can still rapidly and accurately display related characters to a user even if characters to be typeset contain multi-language complex characters. In addition, by pre-uploading typesetting protocol data to the server, the mobile terminal provided by Embodiment 2 of the application realizes the effect that the server may support the typesetting of multiple different mobile terminals.

### Embodiment 5

To further describe the server in Embodiment 3, referring to FIG. 5, a structural block diagram of a server provided by Embodiment 5 of the application is shown. The server may include a pre-receiving module 520, a protocol judging module 540, a protocol receiving module 560, an information receiving module 342, a protocol searching module 344 and a content typesetting module 346.

The pre-receiving module 520 is configured to receive unique identification information uploaded by a mobile terminal.

The protocol judging module 540 is configured to judge whether typesetting protocol data corresponding to the unique identification information has already been stored. The typesetting protocol data includes header information, common character typesetting information and special character typesetting information. The header information includes font size information, font style information and font height information during typesetting. The common character typesetting information includes width information of a single character. The special character typesetting information includes supported type information of the special character, typesetting type information of the special character, and character data corresponding to the typesetting type information of the special character.

The protocol receiving module 560 is configured to feed back an uploading determination instruction to the mobile terminal if the typesetting protocol data corresponding to the unique identification information has not yet been stored, so as to receive and store the typesetting protocol data uploaded by the mobile terminal.

The information receiving module 342 is configured to receive the unique identification information, contents to be typeset and screen information which are uploaded by the mobile terminal.

The protocol searching module 344 is configured to search for the typesetting protocol data corresponding to the mobile terminal according to the unique identification information.

The content typesetting module 346 is configured to typeset the contents to be typeset according to the screen information and the typesetting protocol data, and feed back the typeset contents to the mobile terminal.

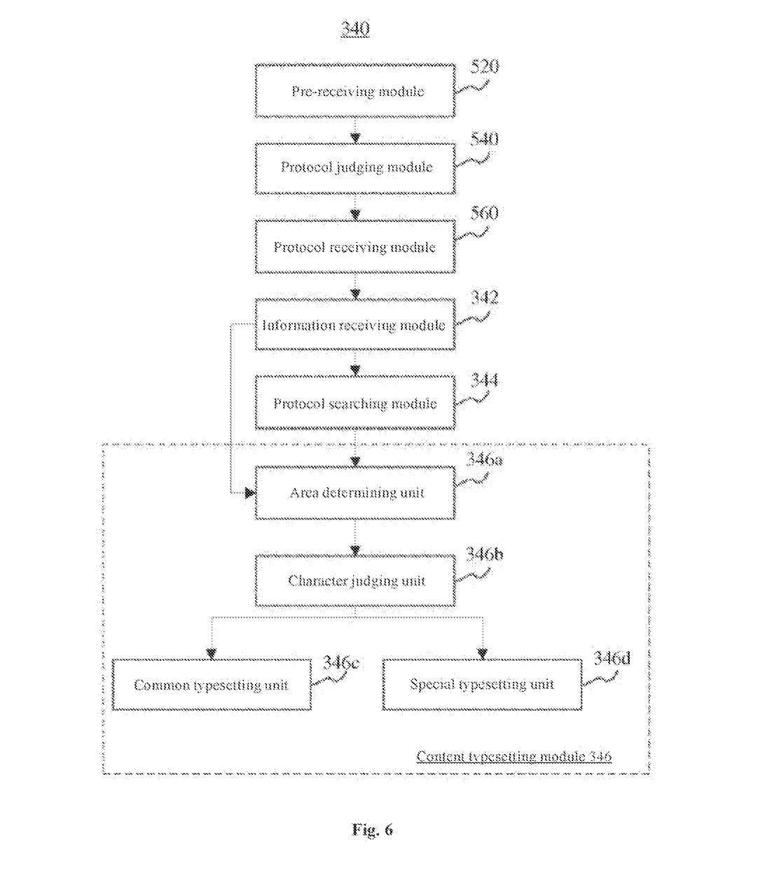

Specifically, the content typesetting module 346 may specifically include: an area determining unit 346a, a character judging module 346b, a common typesetting unit 346c and a special typesetting unit 346d, as shown in FIG. 6. The area determining unit 346a is configured to determine a typesetting area according to the screen information. The character judging module 346b is configured to judge in turn whether each character contained in the contents to be typeset is a special character. The common typesetting unit 346c is configured to typeset the character to the typesetting area according to the common character typesetting information if the character contained in the contents to be typeset is not a special character. The special typesetting unit 346d is configured to typeset the character to the typesetting area according to the special character typesetting information if the character contained in the characters to be typeset is a special character.

Specifically, the special typesetting unit 346d may specifically include: a typesetting judging subunit 702 and a special typesetting subunit 704, as shown in FIG. 7. Wherein, the typesetting judging subunit 702 is configured to judge, according to the supported type information of the special character, whether the typesetting of the current special character is supported; and the special typesetting subunit 704 is configured to typeset the current special character to the typesetting area according to the typesetting type information of the special character and the character data corresponding to the typesetting type information of the special character if the typesetting judging subunit 702 judges that the typesetting of the current special character is supported.

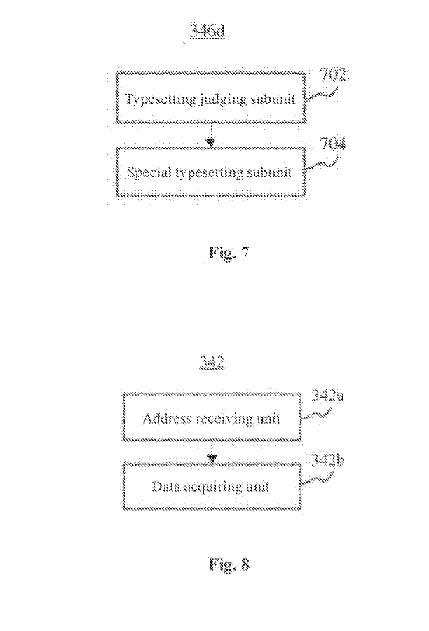

In addition, the information receiving module 342 may also specifically include: an address receiving unit 342a and a data acquiring unit 342b, as shown in FIG. 8. Wherein, the address receiving unit 342a is configured to receive a webpage address uploaded by the mobile terminal; and the data acquiring unit 342b is configured to acquire webpage data according to the webpage address, and use the acquired webpage data as the contents to be typeset.

In conclusion, by completing a typesetting process via a server and then issuing a typeset text area to a mobile terminal, the server provided by Embodiment 5 of the application solves the problems of a low typesetting speed or poor typesetting effect of the mobile terminal caused by the poor typesetting capability provided by the mobile terminal, and achieves the effect that the mobile terminal can rapidly and accurately complete the typesetting process by means of the server, and can still rapidly and accurately display related characters to a user even if characters to be typeset contain multi-language complex characters. In addition, by pre-uploading typesetting data to the server via the mobile terminal, the server provided by Embodiment 5 of the application realizes the effect that the server may support the typesetting of multiple different mobile terminals. In another aspect, by adding complex character typesetting information into the typesetting data uploaded by the mobile terminal, the server provided by Embodiment 5 of the application realizes the effect that the server may support the typesetting of multi-language characters.

It should be noted that, when the typesetting system, the mobile terminal and the server provided by the above embodiments perform typesetting, the division of all the above functional modules is just illustrative; however, in practical application, the above functions may be distributed to and completed by different functional modules according to requirements, that is, the interior structure of the device is divided into different functional modules to implement all or a part of functions described above. In addition, the typesetting system, the mobile terminal and the server provided by the above embodiments and the typesetting method embodiments belong to the same conception. For the specific implementation process, refer to the method embodiments, which will not be redundantly described herein. Those of ordinary skill in the art may understand that all or a part of the steps of the foregoing embodiments may be implemented by hardware or a program instructing related hardware. The program may be stored in a computer readable storage medium. The above-mentioned storage medium may be a read-only memory, a magnetic disk, an optical disk, etc.

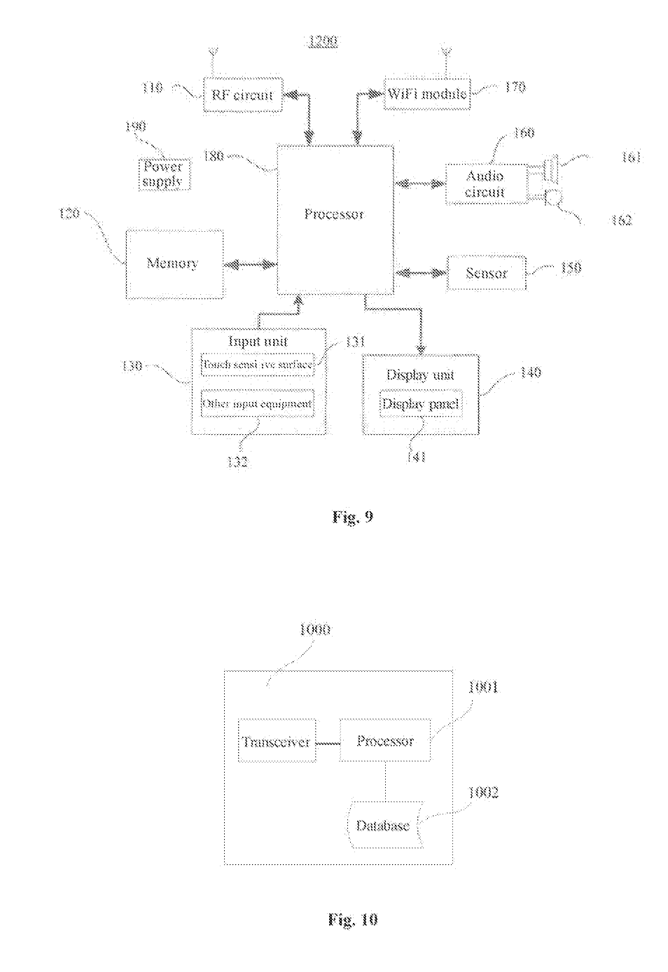

FIG. 9 is a structural schematic diagram of terminal equipment related in the embodiments of the application. The terminal equipment may be applied to implement the typesetting method provided by the above embodiments. Specifically:

The terminal equipment 900 may include an RF (Radio Frequency) circuit 110, a memory 120 containing one or more computer readable storage media, an input unit 130, a display unit 140, a sensor 150, an audio circuit 160, a WiFi (wireless fidelity) module 170, a processor 180 containing one or more processing cores, a power supply 190 and other components. It should be appreciated by those skilled in the art that the structure of the terminal equipment as shown in FIG. 9 is not intended to limit the terminal equipment, and the terminal equipment may include more or less components that shown in the figure, or certain combined components, or a different arrangement of the components. Wherein:

The RF circuit 110 may be configured to receive and transmit signals during the process of receiving/sending a message or in a call. Particularly, downlink information of a base station is processed by one or more processors 180 after being received; in addition, the related uplink data is sent to the base station. In general, the RF circuit 110 includes, but not limited to, an antenna, at least one amplifier, a tuner, one or more oscillators, a Subscriber Identity Module (SIM) card, a transceiver, a coupler, a Low Noise Amplifier (LNA), a duplexer and so on. Besides, the RF circuit 110 may also communicate with a network or other equipment through radio communication. The radio communication may use any communication standard or protocol, including but not limited to, Global System of Mobile Communication (GSM), General Packet Radio Service (GPRS), Code Division Multiple Access (CDMA), Wideband Code Division Multiple Access (WCDMA), Long Term Evolution (LTE), E-mail, Short Messaging Service (SMS), etc.

The memory 120 may be configured to store software programs and modules, and the processor 180 executes various functional applications and data processing by running the software programs and modules stored in the memory 120. The memory 120 may mainly include a program storage region and a data storage region, wherein the program storage region may store operating systems, application programs required by at least one function (for example, a function of playing voice, a function of playing images or the like), etc.; the data storage region may store data (for example, voice data, telephone book, etc) and the like created according to the use of the terminal equipment 900. Besides, the memory 120 may include a high-speed random access memory or a nonvolatile memory, for example, at least one disk storage device, a flash memory device or other volatile solid-state storage devices. Correspondingly, the memory 120 may also include a memory controller for providing the access to the memory 120 for the processor 180 and the input unit 130.

The input unit 130 may be configured to receive input number or character information, and generate the input of a keyboard, a mouse, an operating bar, an optical or a trackball signal associated with user settings and function controls. Specifically, the input unit 130 may include a touch sensitive surface 131 and other input equipment 132. The touch sensitive surface 131, also known as a touch display screen or touch pad, may collect touch operations of a user over or nearby it (for example, operations performed over the touch sensitive surface 131 or nearby the touch sensitive surface 131 by a user via a finger, a stylus or any suitable object or accessory), and drive corresponding connecting devices according to a preset program. Optionally, the touch sensitive surface 131 may include a touch detector and a touch controller. Wherein, the touch detector detects a touch orientation of the user, and detects a signal caused by a touch operation and then transmits the signal to the touch controller. The touch controller receives touch information from the touch detector, converts the touch information into the coordinates of a touch point, then sends the coordinates to the processor 180, and receives and executes a command sent by the processor 180. Besides, the touch sensitive surface 131 may be realized in a resistance type, a capacitance type, an infrared ray type, a surface acoustic wave type or other types. Other than the touch sensitive surface 131, the input unit 130 may further include other input equipment 132. Specifically, the other input equipment 132 may include, but not limited to, one or more of a physical keyboard, a function key (such as a volume control key, a switch key, etc.), a trackball, a mouse, an operating bar, etc.

The display unit 140 may be configured to display information input by a user or information provided to the user and various graphic user interfaces of the terminal equipment 900. These graphic user interfaces may be composed of graphs, texts, icons, videos and any combination thereof. The display unit 140 may include a display panel 141, and optionally, the display unit 140 may be configured in form of a Liquid Crystal Display (LCD), an Organic Light-Emitting Diode (OLED), etc. Further, the touch sensitive surface 131 may cover the display panel 141. After detecting a touch operation over or nearby the touch sensitive surface 131, the touch sensitive surface 131 transmits it to the processor 180 to determine the type of the touch event. Subsequently, the processor 180 provides a corresponding visual output on the display panel 141 according to the type of the touch event. Although the touch sensitive surface 131 and the display panel 141 are regarded as two independent components for realizing input and output functions in FIG. 9, the touch sensitive surface 131 and the display panel 141 may be integrated to realize the input and output functions in certain embodiments.

The terminal equipment 900 may further include at least one sensor 150, for example, an optical sensor, a motion sensor and other sensors. Specifically, the optical sensor may include an ambient optical sensor and a proximity sensor, wherein the ambient optical sensor may adjust the brightness of the display panel 141 according to the brightness of the ambient light, and the proximity sensor may turn off the display panel 141 and/or backlight when the terminal equipment 900 is moved toward ears. As one of motion sensors, a gravity acceleration sensor may detect the magnitude of acceleration in each direction (three axes generally) and the magnitude and direction of the gravity while at a standstill, and may be configured to identify applications (for example, the switchover between a horizontal screen and a vertical screen, related games, magnetometer posture calibration) of mobile phone postures, vibration identification associated functions (for example, pedometer, knock), etc.; and, the terminal equipment 900 may be further configured with a gyro, a barometer, a hygrometer, a thermometer, an infrared sensor and other sensors, which will not be redundantly described herein.

The audio circuit 160, a loudspeaker 161 and a microphone 162 may provide an audio interface between the user and the terminal equipment 900. The audio circuit 160 may convert the received audio data into electric signals, and transmits the electric signals to the loudspeaker 161, and then the loudspeaker 161 converts the electric signals into acoustical signals for output; in another aspect, the microphone 162 converts the collected acoustical signals into electric signals, and then the audio circuit 160 converts the electric signals into audio data after receiving and outputs the audio data to the processor 180 for processing. Then, the audio data is sent to, for example, another terminal equipment, by the RF circuit 110, or the audio data is output to the memory 120 for further processing. The audio circuit 160 may include an earplug socket for providing the communication between a peripheral earphone and the terminal equipment 900.

WiFi belongs to short-distance radio transmission technology. The terminal equipment 900 may assist a user to receive or send E-mails, browse webpages and access streaming media via the WiFi unit 170, and provide the access to wireless wideband internet for the user. Although the WiFi unit 170 is shown in FIG. 9, it is appreciated that the WiFi unit 170 is not a necessary constituent of the terminal equipment 900, and may be omitted absolutely as required without changing the scope of the essence of the application.

The processor 180 is a control center of the terminal equipment 900, the processor 180 connects all components of the whole mobile phone via various interfaces and lines, and executes various functions of the terminal equipment 900 and processes data by running or executing the software programs and/or modules stored in the memory 120 and invoking the data stored in the memory 120, thereby monitoring the mobile phone as a whole. Optionally, the processor 180 may include one or more processing cores; and, preferably, the processor 180 may integrate an application processor and a modem processor, wherein the application processor mainly processes operating systems, user interfaces and application programs, etc., while the modem processor mainly processes radio communication. It is appreciated that the above modem processor may also not be integrated in the processor 180.

The terminal equipment 900 may further include a power supply 190 (for example, a battery) for supplying power to all components. Preferably, the power supply may be in logic connection with the processor 180 via a power supply management system so as to manage charging, discharging and power consumption and realize other functions via the power supply management system. The power supply 190 may further include one or more direct current or alternating current power supplies, a recharging system, a power supply fault detection circuit, a power supply adapter or inverter, a power supply status indicator or any other component.

The terminal equipment 900 may further include a camera, a Bluetooth module and so on, although not shown, which will not be redundantly described herein. Specifically, in this embodiment, the display unit of the terminal equipment is a touch screen display, and the terminal equipment further includes a memory and one or more programs, wherein the one or more programs are stored in the memory. In addition, the one or more programs, configured to be executed by one or more processors, include instructions for performing the following operations: uploading unique identification information, contents to be typeset and screen information to a server, the unique identification information corresponds to typesetting protocol data required by typesetting; and receiving the typeset content fed back by the server, the typeset contents are contents which are acquired after the server typesets the contents to be typeset according to the typesetting protocol data and the screen information.

Further, the memory is further configured to store the following instructions: generating the unique identification information according to the typesetting protocol data to be uploaded; uploading the unique identification information to the server so that the server judges whether it is required to upload the typesetting protocol data; and uploading the typesetting protocol data to the server after receiving an uploading determination instruction fed back by the server.

Referring to FIG. 10, the embodiments of the application further provide a server. The server includes a transceiver 1000, a processor 1001 and a database 1002 connected with the transceiver 1000 and the processor 1001. The transceiver 1000 is configured to receive unique identification information, contents to be typeset and screen information which are uploaded by a mobile terminal. The processor 1001 is configured to search the database 1002 for typesetting protocol data corresponding to the mobile terminal according to the unique identification information. The processor 1001 typesets the contents to be typeset according to the screen information and the typesetting protocol data, and feeds back the typeset content to the mobile terminal via the transceiver 1000.

Further, the transceiver 1000 is further configured to receive the unique identification information uploaded by the mobile terminal. The processor 1001 is configured to judge whether the typesetting protocol data corresponding to the unique identification information has already been stored in the database 1002; and feed back an uploading determination instruction to the mobile terminal via the transceiver 1000 if the typesetting protocol data corresponding to the unique identification information has not yet been stored, so as to receive and store the typesetting protocol data uploaded by the mobile terminal.

Further, the typesetting protocol data includes header information, common character typesetting information and special character typesetting information. The header information includes font size information, font style information and font height information during typesetting. The common character typesetting information includes width information of a single character. The special character typesetting information includes the supported type information of the special character, typesetting type information of the special character, and character data corresponding to the typesetting type information of the special character.

Further, the processor 1001 is configured to determine a typesetting area according to the screen information; judge in turn whether each character contained in the contents to be typeset is a special character; typeset the character to the typesetting area according to the common character typesetting information if the character contained in the contents to be typeset is not a special character; and typeset the character to the typesetting area according to the special character typesetting information if the character contained in the characters to be typeset is a special character.

Further, the processor 1001 is configured to judge, according to the supported type information of the special character, whether the typesetting of the current special character is supported; and typeset the current special character to the typesetting area according to the typesetting type information of the special character and the character data corresponding to the typesetting type information of the special character if the typesetting of the current special character is supported.

Further, the transceiver 1000 is configured to receive a webpage address uploaded by the mobile terminal; and the processor 1001 acquires webpage data according to the webpage address, and uses the acquired webpage data as the contents to be typeset.

Wherein, the transceiver 1000 may be a wireless interface or wired interface for receiving and sending data.

The embodiments of the application further provide a computer readable storage medium, in which one or more programs are stored. The one or more programs are executed by one or more processors to implement a typesetting method. The method includes: uploading unique identification information, contents to be typeset and screen information to a server, the unique identification information corresponds to typesetting protocol data required by typesetting; and receiving the typeset content fed back by the server, the typeset content being a content which is acquired after the server typesets the contents to be typeset according to the typesetting protocol data and the screen information.

Further, before uploading the unique identification information, the contents to be typeset and the screen information to a server, the method further includes: generating the unique identification information according to the typesetting protocol data to be uploaded; uploading the unique identification information to the server so that the server judges whether it is required to upload the typesetting protocol data; and uploading the typesetting protocol data to the server after receiving an uploading determination instruction fed back by the server.

The embodiments of the application further provide a computer readable storage medium, in which one or more programs are stored. The one or more programs are executed by one or more processors to implement a typesetting method. The method includes: receiving unique identification information, contents to be typeset and screen information which are uploaded by a mobile terminal; searching for typesetting protocol data corresponding to the mobile terminal according to the unique identification information; and typesetting the contents to be typeset according to the screen information and the typesetting protocol data, and feeding back the typeset content to the mobile terminal.

Further, before receiving the unique identification information, the contents to be typeset and the screen information which are uploaded by the mobile terminal, the method further includes: receiving the unique identification information uploaded by the mobile terminal; judging whether typesetting protocol data corresponding to the unique identification information has already been stored; and feeding back an uploading determination instruction to the mobile terminal if the typesetting protocol data corresponding to the unique identification information has not yet been stored, so as to receive and store the typesetting protocol data uploaded by the mobile terminal.

Further, the typesetting protocol data includes header information, common character typesetting information and special character typesetting information; the header information includes font size information, font style information and font height information during typesetting; the common character typesetting information includes width information of a single character; and the special character typesetting information includes supported type information of the special character, typesetting type information of the special character, and character data corresponding to the typesetting type information of the special character.

Further, typesetting the contents to be typeset according to the screen information and the typesetting protocol data specifically includes: determining a typesetting area according to the screen information; judging in turn whether each character contained in the contents to be typeset is a special character; typesetting the character to the typesetting area according to the common character typesetting information if a character contained in the contents to be typeset is not a special character; and typesetting the character to the typesetting area according to the special character typesetting information if the character contained in the characters to be typeset is a special character.

Further, typesetting the character to the typesetting area according to the special character typesetting information specifically includes: judging, according to the supported type information of the special character, whether the typesetting of the current special character is supported; and typesetting the current special character to the typesetting area according to the typesetting type information of the special character and the character data corresponding to the typesetting type information of the special character if the typesetting of the current special character is supported.

Further, receiving the unique identification information, the contents to be typeset and the screen information which are uploaded by the mobile terminal specifically includes: receiving a webpage address uploaded by the mobile terminal; and acquiring webpage data according to the webpage address, and using the acquired webpage data as the contents to be typeset.

The foregoing descriptions are merely preferred embodiments of the application, and are not intended to limit the invention. Any modification, equivalent substitution, improvement or the like made within the spirit and principle of the application shall fall into the protection scope of the application.

1. (canceled)

2. The A typesetting method, wherein the method comprises:
receiving unique identification information, contents to be typeset and screen information which are uploaded by a mobile terminal;
searching for typesetting protocol data corresponding to the mobile terminal according to the unique identification information;
typesetting the contents to be typeset according to the screen information and the typesetting protocol data;
feeding back the typeset contents to the mobile terminal; and
wherein before receiving the unique identification information, the contents to be typeset and the screen information which are uploaded by the mobile terminal, the method further comprises:
receiving the unique identification information uploaded by the mobile terminal,
judging whether the typesetting protocol data corresponding to the unique identification information has been stored, and
feeding back an uploading determination instruction to the mobile terminal if the typesetting protocol data corresponding to the unique identification information has not been stored, so as to receive and store the typesetting protocol data uploaded by the mobile terminal.

3. The typesetting method according to claim 2, wherein the typesetting protocol data comprises header information, common character typesetting information and special character typesetting information;
the header information comprises font size information, font style information and font height information during typesetting;
the common character typesetting information comprises width information of a single character; and
the special character typesetting information comprises supported type information of the special character, typesetting type information of the special character, and character data corresponding to the typesetting type information of the special character.

4. The typesetting method according to claim 3, wherein typesetting the contents to be typeset according to the screen information and the typesetting protocol data specifically comprises:
determining a typesetting area according to the screen information;
judging in turn whether each character contained in the contents to be typeset is a special character;
typesetting the character to the typesetting area according to the common character typesetting information if the character contained in the contents to be typeset is not a special character; and
typesetting the character to the typesetting area according to the special character typesetting information if the character contained in the characters to be typeset is a special character.

5. The typesetting method according to claim 4, wherein typesetting the character to the typesetting area according to the special character typesetting information specifically comprises:
judging, according to the supported type information of the special character, whether the typesetting of the current special character is supported; and
typesetting the current special character to the typesetting area according to the typesetting type information of the special character and the character data corresponding to the typesetting type information of the special character if the typesetting of the current special character is supported.

6. The typesetting method according to claim 2, wherein receiving the unique identification information, the contents to be typeset and the screen information which are uploaded by the mobile terminal specifically comprises:
receiving a webpage address uploaded by the mobile terminal;
acquiring webpage data according to the webpage address; and
using the acquired webpage data as the contents to be typeset.

7. (canceled)

8. A typesetting method, wherein the method comprises:
uploading unique identification information, contents to be typeset and screen information to a server, the unique identification information corresponds to typesetting protocol data required by typesetting;
receiving the typeset content fed back by the server, the typeset contents are contents which are acquired by the server after typesetting the contents to be typeset according to the typesetting protocol data and the screen information; and
wherein, before uploading the unique identification information, the contents to be typeset and the screen information to the server, the method further comprises:
generating the unique identification information according to the typesetting protocol data to be uploaded,
uploading the unique identification information to the server so that the server judges whether it is required to upload the typesetting protocol data, and
uploading the typesetting protocol data to the server after receiving an uploading determination instruction fed back by the server.

9. (canceled)

10. A server, wherein the server comprises:
an information receiving module configured to receive unique identification information, contents to be typeset and screen information which are uploaded by a mobile terminal;
a protocol searching module configured to search for typesetting protocol data corresponding to the mobile terminal according to the unique identification information;
a content typesetting module configured to typeset the contents to be typeset according to the screen information and the typesetting protocol data and feed back the typeset contents to the mobile terminal;
a pre-receiving module configured to receive the unique identification information uploaded by the mobile terminal;
a protocol judging module configured to judge whether the typesetting protocol data corresponding to the unique identification information has been stored; and
a protocol receiving module configured to feed back an uploading determination instruction to the mobile terminal if the typesetting protocol data corresponding to the unique identification information has not been stored, so as to receive and store the typesetting protocol data uploaded by the mobile terminal.

11. The server according to claim 10, wherein the typesetting protocol data comprises header information, common character typesetting information and special character typesetting information; wherein the header information comprises font size information, font style information and font height information during typesetting;
the common character typesetting information comprises width information of a single character; and
the special character typesetting information comprises the supported type information of the special character, typesetting type information of the special character, and character data corresponding to the typesetting type information of the special character.

12. The server according to claim 11, wherein the content typesetting module specifically comprises:
an area determining unit configured to determine a typesetting area according to the screen information;
a character judging module configured to judge in turn whether each character contained in the contents to be typeset is a special character;
a common typesetting unit configured to typeset the character to the typesetting area according to the common character typesetting information if a character contained in the contents to be typeset is not a special character; and
a special typesetting unit configured to typeset the character to the typesetting area according to the special character typesetting information if a character contained in the characters to be typeset is a special character.

13. The server according to claim 12, wherein the special typesetting unit specifically comprises:
a typesetting judging subunit configured to judge, according to the supported type information of the special character, whether the typesetting of the current special character is supported; and
a special typesetting subunit configured to typeset the current special character to the typesetting area according to the typesetting type information of the special character and the character data corresponding to the typesetting type information of the special character if the typesetting judging subunit judges that the typesetting of the current special character is supported.

14. The server according to claim 11 wherein the information receiving module specifically comprises:
an address receiving unit and a data acquiring unit; wherein
the address receiving unit is configured to receive a webpage address uploaded by the mobile terminal; and
the data acquiring unit is configured to acquire webpage data according to the webpage address, and use the acquired webpage data as the contents to be typeset.

15. (canceled)

16. A mobile terminal, wherein the mobile terminal comprises:
an information uploading module configured to upload unique identification information, contents to be typeset and screen information to a server, the unique identification information corresponds to typesetting protocol data required by typesetting;
a typesetting receiving module configured to receive the typeset contents fed back by the server, the typeset contents are contents which are acquired by the server after typesetting the contents to be typeset according to the typesetting protocol data and the screen information;
an information generation module configured to generate the unique identification information according to the typesetting protocol data to be uploaded;
a pre-uploading module configured to upload the unique identification information to the server so that the server judges whether it is required to upload the typesetting protocol data; and
a data uploading module configured to upload the typesetting protocol data to the server after receiving an uploading determination instruction fed back by the server.

17. A typesetting system, wherein the typesetting system comprises:
a server, wherein the server comprises:
an information receiving module configured to receive unique identification information, contents to be typeset and screen information which are uploaded by a mobile terminal,
a protocol searching module configured to search for typesetting protocol data corresponding to the mobile terminal according to the unique identification information,
a content typesetting module configured to typeset the contents to be typeset according to the screen information and the typesetting protocol data and
feed back the typeset contents to the mobile terminal,
a pre-receiving module configured to receive the unique identification information uploaded by the mobile terminal,
a protocol judging module configured to judge whether the typesetting protocol data corresponding to the unique identification information has been stored, and
a protocol receiving module configured to feed back an uploading determination instruction to the mobile terminal if the typesetting protocol data corresponding to the unique identification information has not been stored, so as to receive and store the typesetting protocol data uploaded by the mobile terminal; and
a mobile, wherein the mobile terminal comprises:
an information uploading module configured to upload unique identification information, contents to be typeset and screen information to a server, the unique identification information corresponds to typesetting protocol data required by typesetting,
a typesetting receiving module configured to receive the typeset contents fed back by the server, the typeset contents are contents which are acquired by the server after typesetting the contents to be typeset according to the typesetting protocol data and the screen information,
an information generation module configured to generate the unique identification information according to the typesetting protocol data to be uploaded,
a pre-uploading module configured to upload the unique identification information to the server so that the server judges whether it is required to upload the typesetting protocol data, and
a data uploading module configured to upload the typesetting protocol data to the server after receiving an uploading determination instruction fed back by the server.
